(19) United States
(12) Patent Application Publication
(10) Pub. No.: US 2025/0015355 A1
(43) Pub. Date: Jan. 9, 2025

(54) NONAQUEOUS ELECTROLYTE ENERGY STORAGE DEVICE

(71) Applicant: GS Yuasa International Ltd., Kyoto-shi, Kyoto (JP)

(72) Inventor: Jinya Ueda, Kyoto (JP)

(21) Appl. No.: 18/710,258

(22) PCT Filed: Nov. 21, 2022
(86) PCT No.: PCT/JP2022/042969

§ 371 Date: May 15, 2024

(30) Foreign Application Priority Data
Nov. 22, 2021 (JP) 2021-189727

(51) Int. Cl. H01M 10/0569; H01G 11/06; H01G 11/52; H01G 11/60; H01M 10/0525; H01M 50/431; H01M 50/449; H01M 50/489

(52) U.S. Cl. CPC H01M 10/0569; H01G 11/06; H01G 11/52; H01G 11/60; H01M 10/0525; H01M 50/431; H01M 50/449; H01M 50/489

(57) ABSTRACT

A nonaqueous electrolyte energy storage device according to one aspect of the present invention includes: a negative electrode having a negative active material layer containing lithium metal; a positive electrode having a positive active material layer; a nonaqueous electrolyte containing a liquid containing a fluorine atom; and a separator having a substrate layer and an inorganic particle layer layered on a surface of the substrate layer, wherein the surface of the negative active material layer and the surface of the inorganic particle layer are stacked so as to face each other, and the separator has an air permeability of 110 [sec/100 cm³] or more and 450 [sec/100 cm³] or less.

### TECHNICAL FIELD

The present invention relates to a nonaqueous electrolyte energy storage device.

### BACKGROUND ART

Nonaqueous electrolyte secondary batteries typified by lithium ion secondary batteries are often used for electronic devices such as personal computers and communication terminals, motor vehicles, and the like since, because the batteries are high in energy density. The nonaqueous electrolyte secondary battery generally includes a pair of electrodes electrically isolated from each other by a separator, and a nonaqueous electrolyte interposed between the electrodes, and is configured to allow charge transport ions to be transferred between both the electrodes for charge-discharge. In addition, capacitors such as lithium ion capacitors and electric double layer capacitors are also widely used as nonaqueous electrolyte energy storage devices other than the nonaqueous electrolyte secondary batteries.

In recent years, in order to increase the capacity of nonaqueous electrolyte secondary batteries, it has been required to increase the capacity of the negative electrode. Lithium metal has a significantly larger discharge capacity per active material mass than graphite, which is currently widely used as a negative active material for lithium ion secondary batteries. Therefore, a nonaqueous electrolyte secondary battery containing lithium metal as a negative active material has been proposed (see JP-A-2011-124154).

### PRIOR ART DOCUMENT

### Patent Document

Patent Document 1: JP-A-2011-124154

### SUMMARY OF THE INVENTION

### Problems to be Solved by the Invention

However, in a nonaqueous electrolyte energy storage device in which lithium metal is used as a negative active material, lithium metal may be deposited in a dendritic form at the surface of the negative electrode during charge (hereinafter, lithium metal in a dendritic form is referred to as a “dendrite”). When the dendrite grows, the dendrite penetrates the separator and comes into contact with the positive electrode, which may cause a short circuit.

An object of the present invention is to provide a nonaqueous electrolyte energy storage device having a high effect of suppressing occurrence of a short circuit.

### Means for Solving the Problems

A nonaqueous electrolyte energy storage device according to one aspect of the present invention includes: a negative electrode having a negative active material layer containing lithium metal; a positive electrode having a positive active material layer; a nonaqueous electrolyte containing a liquid containing a fluorine atom; and a separator having a substrate layer and an inorganic particle layer layered on a surface of the substrate layer, wherein the surface of the negative active material layer and the surface of the inorganic particle layer are stacked so as to face each other, and the separator has an air permeability of 110 [sec/100 cm³] or more and 450 [sec/100 cm³] or less.

### Advantages of the Invention

The nonaqueous electrolyte energy storage device according to one aspect of the present invention has a high effect of suppressing occurrence of a short circuit.

### BRIEF DESCRIPTION OF THE DRAWINGS

FIG. 1 is a see-through perspective view illustrating an embodiment of a nonaqueous electrolyte energy storage device.

FIG. 2 is a schematic diagram illustrating an embodiment of an energy storage apparatus configured by assembling a plurality of nonaqueous electrolyte energy storage devices.

### MODE FOR CARRYING OUT THE INVENTION

First, the outline of a nonaqueous electrolyte energy storage device disclosed in the present specification will be described.

A nonaqueous electrolyte energy storage device according to one aspect of the present invention includes: a negative electrode having a negative active material layer containing lithium metal; a positive electrode having a positive active material layer; a nonaqueous electrolyte containing a liquid containing a fluorine atom; and a separator having a substrate layer and an inorganic particle layer layered on a surface of the substrate layer, wherein the surface of the negative active material layer and the surface of the inorganic particle layer are stacked so as to face each other, and the separator has an air permeability of 110 [sec/100 cm³] or more and 450 [sec/100 cm³] or less.

According to the nonaqueous electrolyte energy storage device, an effect of suppressing occurrence of a short circuit is high. Although the reason for this is not clear, the following reason is presumed. As described above, in the nonaqueous electrolyte energy storage device in which lithium metal is used for the negative active material, the dendrite may be precipitated on the surface of the negative electrode during charge, and when the dendrite penetrates the separator and come into contact with the positive electrode, which causes a short circuit. When the nonaqueous electrolyte of the nonaqueous electrolyte energy storage device contains a liquid containing a fluorine atom, a uniform and stable film is formed on the surface of the negative active material layer, and precipitation and growth of a dendrite are suppressed. In addition, since the negative active material layer contains lithium metal, and the inorganic particle layer is interposed between the negative active material layer and the substrate layer of the separator, blocking of pores of the substrate layer of the separator due to compression caused by a volume change of the negative active material layer is suppressed. Therefore, the current distribution at the interface between the negative active material layer and the separator is uniformly maintained, so that the formation of a dendrite is suppressed. Further, by using the separator having an air permeability of 110 [sec/100 cm³] or more and 450 [sec/100 cm³] or less, the concentration distribution of lithium ions in the nonaqueous electrolyte in the vicinity of the surface of the negative active material layer is made uniform, so that precipitation and growth of a dendrite are suppressed. As described above, it is presumed that the nonaqueous electrolyte energy storage device has a high effect of suppressing the formation of a dendrite and a high effect of suppressing the occurrence of a short circuit.

The “air permeability” is a value measured by a “Gurley tester method” in accordance with JIS-P-8117 (2009). The test piece of the separator used for the measurement has dimensions of 50 mm×50 mm.

The air permeability of the separator included in the nonaqueous electrolyte energy storage device is measured using a separator prepared by the following method. When the separator before assembling the nonaqueous electrolyte energy storage device can be prepared, the separator is cut out as it is to obtain a test piece. In the case of preparing the nonaqueous electrolyte energy storage device after assembly, first, the nonaqueous electrolyte energy storage device is subjected to constant current discharge up to an end-of-discharge voltage in normal use at a current of 0.1 C, and then the nonaqueous electrolyte energy storage device is disassembled in a dry atmosphere. Next, the separator is taken out, washed with a hydrochloric acid of 36% by mass in concentration, further washed with deionized water, and then subjected to vacuum drying at normal temperature for 10 hours or longer. Thereafter, the vacuum-dried separator is cut out to obtain a test piece.

It is preferable that the nonaqueous electrolyte contains a nonaqueous solvent containing a fluorinated solvent, and the content of the fluorinated solvent in the nonaqueous solvent is 12% by volume or more. When the nonaqueous electrolyte contains the nonaqueous solvent containing the fluorinated solvent, a uniform and stable film is formed on the surface of the negative active material layer, oxidation resistance is further enhanced, and occurrence of a short circuit when the nonaqueous electrolyte energy storage device repeats charge-discharge is further suppressed. When the content of the fluorinated solvent in the nonaqueous solvent is 12% by volume or more, the effect of suppressing the occurrence of a short circuit in the nonaqueous electrolyte energy storage device can be further enhanced.

The configuration of a nonaqueous electrolyte energy storage device, the configuration of an energy storage apparatus, and a method for manufacturing the nonaqueous electrolyte energy storage device according to an embodiment of the present invention, and other embodiments will be described in detail. It is to be noted that the names of the respective construction members (respective construction elements) for use in the respective embodiments may be different from the names of the respective construction members (respective construction elements) for use in the background art.

### <Configuration of Nonaqueous Electrolyte Energy Storage Device>

A nonaqueous electrolyte energy storage device according to an embodiment of the present invention (hereinafter, also referred to simply as an “energy storage device”) includes: an electrode assembly including a positive electrode, a negative electrode, and a separator; a nonaqueous electrolyte; and a case that houses the electrode assembly and the nonaqueous electrolyte. The electrode assembly is usually a layered type in which a plurality of positive electrodes and a plurality of negative electrodes are stacked with a separator interposed therebetween, or a wound type in which a positive electrode and a negative electrode are wound in a state of being stacked with a separator interposed therebetween. The nonaqueous electrolyte is present in a state of being contained in the positive electrode, the negative electrode, and the separator. A nonaqueous electrolyte secondary battery (hereinafter, also simply referred to as a “secondary battery”) will be described as an example of the nonaqueous electrolyte energy storage device.

### (Negative Electrode)

The negative electrode includes a negative substrate and a negative active material layer disposed directly on the negative substrate or over the negative substrate with an intermediate layer interposed therebetween.

The negative substrate has conductivity. Whether the negative substrate has “conductivity” or not is determined with the volume resistivity of 10⁷ Ω·cm measured in accordance with JIS-H-0505 (1975) as a threshold. As the material for the negative substrate, a metal such as copper, nickel, stainless steel, or nickel-plated steel, or an alloy thereof, a carbonaceous material, or the like is used. Among these metals and alloys, the copper or copper alloy is preferable. Examples of the negative substrate include a foil, a deposited film, a mesh, and a porous material, and a foil is preferable from the viewpoint of cost. Accordingly, the negative substrate is preferably a copper foil or a copper alloy foil. Examples of the copper foil include rolled copper foils and electrolytic copper foils.

The average thickness of the negative substrate is preferably 2 μm or more and 35 μm or less, more preferably 3 μm or more and 30 μm or less, still more preferably 4 μm or more and 25 μm or less, and particularly preferably 5 μm or more and 20 μm or less. When the average thickness of the negative substrate falls within the above range, it is possible to enhance the energy density per volume of a secondary battery while increasing the strength of the negative substrate.

The intermediate layer is a layer disposed between the negative substrate and the negative active material layer. The intermediate layer contains a conductive agent such as carbon particles, thereby reducing contact resistance between the negative substrate and the negative active material layer. The configuration of the intermediate layer is not particularly limited, and includes, for example, a binder and a conductive agent.

### (Negative Active Material Layer)

The negative active material layer contains lithium metal in a charged state. The lithium metal is a component that functions as a negative active material. The lithium metal may be present as pure metal lithium substantially composed only of a lithium element, or may be present as a lithium alloy containing other metal elements. Examples of the lithium alloy include a lithium silver alloy, a lithium zinc alloy, a lithium calcium alloy, a lithium aluminum alloy, a lithium magnesium alloy, and a lithium indium alloy. The lithium alloy may contain a plurality of metal elements other than lithium element.

The content of the lithium element in the negative active material layer may be 90% by mass or more, 99% by mass or more, or 100% by mass.

The negative active material layer may be a non-porous layer (solid layer). The negative active material layer may be a layer composed substantially of only lithium metal. The negative active material layer may be a pure-metallic lithium foil or a lithium alloy foil. The negative active material layer may be a porous layer including particles containing lithium metal. The negative active material layer, which is a porous layer including particles containing lithium metal, may further have, for example, resin particles, inorganic particles, and the like.

The negative active material layer, that is, the layer containing lithium metal is preferably a layer that is also present in a discharged state, that is, a layer that is present in all states from a charged state to a discharged state. The average thickness of the negative active material layer in a discharged state is preferably 5 μm or more and 1,000 μm or less, more preferably 10 μm or more and 500 μm or less, still more preferably 30 μm or more and 300 μm or less. The average thickness of the negative active material layer refers to the average value of thicknesses measured at any five points of the negative active material layer. When the negative active material containing lithium metal is also present in a discharged state, preferably with the average thickness thereof equal to or more than the above lower limit, a sufficient amount of lithium metal is present, thus providing advantages such as suppressing a decrease in capacity retention ratio, associated with repeated charge-discharge.

It is to be noted that, the negative electrode may not have the negative active material layer in the discharged state, for example, in the case of a nonaqueous electrolyte energy storage device configured such that lithium metal is precipitated on at least a part of the surface of the negative substrate during charge, and substantially all lithium metal on the surface of the negative substrate is eluted as lithium ions in the nonaqueous electrolyte during discharge.

### (Positive Electrode)

The positive electrode includes a positive substrate and a positive active material layer disposed directly on the positive substrate or over the positive substrate with an intermediate layer interposed therebetween. The configuration of the intermediate layer is not particularly limited, and for example, can be selected from the configurations exemplified for the negative electrode.

The positive substrate has conductivity. As the material of the positive substrate, a metal such as aluminum, titanium, tantalum, or stainless steel, or an alloy thereof is used. Among these metals and alloys, aluminum or an aluminum alloy is preferable from the viewpoints of electric potential resistance, high conductivity, and cost. Examples of the positive substrate include a foil, a deposited film, a mesh, and a porous material, and a foil is preferable from the viewpoint of cost. Accordingly, the positive substrate is preferably an aluminum foil or an aluminum alloy foil. Examples of the aluminum or aluminum alloy include A1085, A3003, and A1N30 specified in JIS-H-4000 (2014) or JIS-H-4160 (2006).

The average thickness of the positive substrate is preferably 3 μm or more and 50 μm or less, more preferably 5 μm or more and 40 μm or less, still more preferably 8 μm or more and 30 μm or less, and particularly preferably 10 μm or more and 25 μm or less. When the average thickness of the positive substrate falls within above range, the energy density per volume of the secondary battery can be increased while increasing the strength of the positive substrate.

The positive active material layer includes a positive active material. The positive active material layer contains optional components such as a conductive agent, a binder, a thickener, a filler, or the like as necessary.

The positive active material can be appropriately selected from known positive active materials. As the positive active material for a lithium secondary battery, a material capable of storing and releasing lithium ions is usually used. Examples of the positive active material include lithium-transition metal composite oxides that have an α-NaFeO₂-type crystal structure, lithium-transition metal composite oxides that have a spinel-type crystal structure, polyanion compounds, chalcogenides, and sulfur. Examples of the lithium-transition metal composite oxides that have an α-NaFeO₂-type crystal structure include Li[LiₓNi₍₁₋ₓ₎]O₂(0≤x<0.5), Li[LiₓNi_{y}Co_{(1-x-y)}]O₂(0≤x<0.5, 0<y<1), Li[LiₓCo₍₁₋ₓ₎]O₂(0≤x<0.5), Li[LiₓNi_{y}Mn_{(1-x-y)}]O₂(0≤x<0.5, 0<y<1), Li[LiₓNi_{y}Mn_{β}Co_{(1-x-y-β)}]O₂(0≤x<0.5, 0<y, 0<β, 0.5<y+β<1), and Li[LiₓNi_{y}CoβAl_{(1-x-y-β)}]O₂(0≤x<0.5, 0<y, 0<β, 0.5<y+β<1). Examples of the lithium-transition metal composite oxides that have a spinel-type crystal structure include LiₓMn₂O₄ and LiₓNi_{y}Mn_{(2-y)}O₄. Examples of the polyanion compounds include LiFePO₄, LiMnPO₄, LiNiPO₄, LiCoPO₄, Li₃V₂ (PO₄)₃, Li₂MnSiO₄, and Li₂CoPO₄F. Examples of the chalcogenides include a titanium disulfide, a molybdenum disulfide, and a molybdenum dioxide. Some of atoms or polyanions in these materials may be substituted with atoms or anion species composed of other elements. The surfaces of these materials may be coated with other materials. In the positive active material layer, one of these materials may be used singly, or two or more thereof may be used in mixture.

The positive active material is usually particles (powder). The average particle size of the positive active material is preferably 0.1 μm or more and 20 μm or less, for example. When the average particle size of the positive active material is equal to or more than the lower limit mentioned above, the positive active material is easily manufactured or handled. When the average particle size of the positive active material is equal to or less than the upper limit mentioned above, the electron conductivity of the positive active material layer is improved. It is to be noted that in the case of using a composite of the positive active material and another material, the average particle size of the composite is regarded as the average particle size of the positive active material. In the present invention, the term “average particle size” means a value at which a volume-based integrated distribution calculated in accordance with JIS-Z-8819-2 (2001) is 50% based on a particle size distribution measured by a laser diffraction/scattering method for a diluted solution obtained by diluting particles with a solvent in accordance with JIS-Z-8825 (2013).

A crusher or a classifier is used to obtain a powder with a predetermined particle size. Examples of a crushing method include a method in which a mortar, a ball mill, a sand mill, a vibratory ball mill, a planetary ball mill, a jet mill, a counter jet mill, a whirling airflow type jet mill, or a sieve or the like is used. At the time of crushing, wet-type crushing in coexistence with water or a nonaqueous solvent such as hexane can also be used. As a classification method, a sieve or a wind force classifier or the like is used based on the necessity both in dry manner and in wet manner.

The content of the positive active material in the positive active material layer is preferably 50% by mass or more and 99% by mass or less, more preferably 70% by mass or more and 98% by mass or less, and still more preferably 80% by mass or more and 95% by mass or less. When the content of the positive active material falls within the range mentioned above, a balance can be achieved between the high energy density and productivity of the positive active material layer.

The conductive agent is not particularly limited as long as the agent is a material with conductivity. Examples of such a conductive agent include carbonaceous materials, metals, and conductive ceramics. Examples of the carbonaceous materials include graphite, non-graphitic carbon, and graphene-based carbon. Examples of the non-graphitic carbon include carbon nanofibers, pitch-based carbon fibers, and carbon black. Examples of the carbon black include furnace black, acetylene black, and ketjen black. Examples of the graphene-based carbon include graphene, carbon nanotubes (CNTs), and fullerene. Examples of the form of the conductive agent include a powdery form and a fibrous form. As the conductive agent, one of these materials may be used singly, or two or more thereof may be mixed and used. These materials may be composited and then used. For example, a material in which carbon black and CNT are composited may be used. Among these materials, carbon black is preferable from the viewpoints of electron conductivity and coatability, and in particular, acetylene black is preferable.

The content of the conductive agent in the positive active material layer is preferably 1% by mass or more and 10% by mass or less, more preferably 3% by mass or more and 9% by mass or less. When the content of the conductive agent falls within the above range, the energy density of the secondary battery can be enhanced.

Examples of the binder mentioned above include: thermoplastic resins such as fluororesins (e.g., polytetrafluoroethylene (PTFE), polyvinylidene fluoride (PVDF)), polyethylene, polypropylene, polyacryl, and polyimide; elastomers such as an ethylene-propylene diene rubber (EPDM), sulfonated EPDM, a styrene butadiene rubber (SBR), and a fluororubber; and polysaccharide polymers. As the binder, one of these materials may be used singly, or two or more thereof may be mixed and used.

The content of the binder in the positive active material layer is preferably 1% by mass or more and 10% by mass or less, more preferably 3% by mass or more and 9% by mass or less. When the content of the binder falls within the above range, the positive active material can be stably held.

Examples of the thickener include polysaccharide polymers such as a carboxymethylcellulose (CMC) and a methylcellulose. When the thickener mentioned above has a functional group that is reactive with lithium and the like, the functional group may be deactivated by methylation or the like in advance. As the thickener, one of these materials may be used singly, or two or more thereof may be mixed and used.

The filler is not particularly limited. Examples of the filler include polyolefins such as polypropylene, and polyethylene; inorganic oxides such as silicon dioxide, aluminum oxide, titanium dioxide, calcium oxide, strontium oxide, barium oxide, magnesium oxide, and aluminosilicate; hydroxides such as magnesium hydroxide, calcium hydroxide, and aluminum hydroxide; a carbonate such as calcium carbonate; hardly soluble ionic crystals of calcium fluoride, barium fluoride, barium sulfate, and the like; nitrides such as aluminum nitride, and silicon nitride; and substances derived from mineral resources such as talc, montmorillonite, boehmite, zeolite, apatite, kaolin, mullite, spinel, olivine, sericite, bentonite, and mica; and artificial products thereof. As the filler, one of these materials may be used singly, or two or more thereof may be mixed and used.

The positive active material layer may contain a typical nonmetal element such as B, N, P, F, Cl, Br, and I, a typical metal element such as Li, Na, Mg, Al, K, Ca, Zn, Ga, Ge, Sn, Sr, and Ba, or a transition metal element such as Sc, Ti, V, Cr, Mn, Fe, Co, Ni, Cu, Mo, Zr, Nb, and W as a component other than the positive active material, the conductive agent, the binder, the thickener, and the filler.

The average thickness of the positive active material layer is preferably 5 μm or more and 1,000 μm or less, more preferably 10 μm or more and 500 μm or less, still more preferably 50 μm or more and 300 μm or less. The average thickness of the positive active material layer refers to the average value of thicknesses measured at any five points of the positive active material layer.

### (Separator)

The separator is interposed between the negative active material layer and the positive active material layer. The separator has a substrate layer and an inorganic particle layer layered on a surface of the substrate layer.

Examples of the form of the substrate layer of the separator include a woven fabric, a nonwoven fabric, and a porous resin film. Among these forms, a porous resin film is preferable from the viewpoint of strength, and a nonwoven fabric is preferable from the viewpoint of liquid retaining property of the nonaqueous electrolyte. As the material for the substrate layer of the separator, for example, a polyolefin such as polyethylene or polypropylene is preferable from the viewpoint of shutdown function, and polyimide, aramid, or the like is preferable from the viewpoint of resistance to oxidative decomposition. As the substrate layer of the separator, one of these materials may be used singly, or two or more thereof may be mixed and used, or a material obtained by combining these resins may be used. The substrate layer of the separator may be configured of one layer or two or more layers.

The inorganic particle layer is layered on the surface of the substrate layer. In addition, the surface of the negative active material layer and the surface of the inorganic particle layer are stacked so as to face each other. That is, the inorganic particle layer is interposed between the substrate layer and the negative active material layer. The inorganic particle layer is a porous layer containing inorganic particles. The inorganic particle layer may contain other components such as a binder. When the inorganic particle layer is interposed between the negative active material layer and the substrate layer, clogging of pores of the substrate layer due to compression by volume change of lithium metal is suppressed. Therefore, the current distribution at the interface between the negative active material layer and the separator is uniformly maintained, so that the formation of a dendrite is suppressed. As described above, the nonaqueous electrolyte energy storage device has a high effect of suppressing the formation of a dendrite and a high effect of suppressing the occurrence of a short circuit.

The separator may further include an inorganic particle layer interposed between the substrate layer and the positive active material layer. The inorganic particle layer interposed between the substrate layer and the positive active material layer has the same configuration as the inorganic particle layer interposed between the substrate layer and the negative active material layer.

Examples of the specific type for the material constituting the inorganic particles include oxides such as iron oxide, silicon oxide, aluminum oxide, titanium dioxide, zirconium oxide, calcium oxide, strontium oxide, barium oxide, magnesium oxide and aluminosilicate; hydroxides such as magnesium hydroxide, calcium hydroxide and aluminum hydroxide; nitrides such as aluminum nitride and silicon nitride; carbonates such as calcium carbonate; sulfates such as barium sulfate; hardly soluble ionic crystals of calcium fluoride, barium fluoride, and barium titanate and the like; covalently bonded crystals such as silicon and diamond; and substances derived from mineral resources, such as talc, montmorillonite, boehmite, zeolite, apatite, kaolin, mullite, spinel, olivine, sericite, bentonite and mica, and artificial products thereof. The inorganic particles do not include pure metal lithium particles and lithium alloy particles. As the inorganic particles, those having a lower density among them are preferable from the viewpoint of weight reduction. As the inorganic particles, simple substances or complexes of these substances may be used singly, or two or more thereof may be used in mixture.

The content of the inorganic particles in the inorganic particle layer is preferably 50% by mass or more and 100% by mass or less, more preferably 60% by mass or more and 99% by mass or less, and still more preferably 70% by mass or more and 98% by mass or less.

When the inorganic particle layer contains a binder, the content of the binder in the inorganic particle layer is preferably more than 0% by mass and 50% by mass or less, more preferably 0.5% by mass or more and 40% by mass or less, and still more preferably 1% by mass or more and 30% by mass or less.

The upper limit of the average particle size of the inorganic particles is preferably 1000 nm, more preferably 800 nm, and still more preferably 500 nm. When the average particle size of the inorganic particles is equal to or less than the upper limit mentioned above, precipitation and growth of a dendrite can be suppressed, and suitable battery performance can be obtained. The lower limit of the average particle size is preferably 5 nm, more preferably 8 nm, and still more preferably 10 nm. When the average particle size of the inorganic particles is equal to or more than the lower limit mentioned above, suitable battery performance can be obtained. From these viewpoints, the average particle size of the inorganic particles is preferably 5 nm or more and 1000 nm or less, more preferably 8 nm or more and 800 nm or less, still more preferably 10 nm or more and 1000 nm or less. When such inorganic particles are used, the number of pores per area of the inorganic layer increases, the current distribution becomes more uniform, and the effect of the present invention can be further exhibited.

As the binder of the inorganic particle layer, the same binder as the binder of the positive active material layer can be used.

The lower limit of the air permeability of the separator is 110 [sec/100 cm³], preferably 120 [sec/100 cm³], more preferably 130 [sec/100 cm³], still more preferably 150 [sec/100 cm³], and particularly preferably 160 [sec/100 cm³] from the viewpoint of suppressing the penetration of the grown dendrite through the separator. On the other hand, the upper limit of the air permeability of the separator is 450 [sec/100 cm³], preferably 400 [sec/100 cm³], more preferably 350 [sec/100 cm³], still more preferably 300 [sec/100 cm³], and particularly preferably 260 [sec/100 cm³]. When the air permeability of the separator is equal to or less than the above upper limit, the concentration distribution of lithium ions in the nonaqueous electrolyte in the vicinity of the surface of the negative active material layer is made uniform, so that precipitation and growth of dendrite are suppressed. From these viewpoints, the air permeability of the separator is 110 [sec/100 cm³] or more and 450 [sec/100 cm³] or less, preferably 120 [sec/100 cm³] or more and 400 [sec/100 cm³] or less, more preferably 130 [sec/100 cm³] or more and 350 [sec/100 cm³] or less, still more preferably 150 [sec/100 cm³] or more and 300 [sec/100 cm³] or less, particularly preferably 160 [sec/100 cm³] or more and 260 [sec/100 cm³] or less. The air permeability of the separator is adjusted with the porosity, average thickness, degree of stretching, and the like of the separator. In addition, as the separator with such an air permeability, a commercially available product can be used.

The average thickness of the inorganic particle layer is, for example, preferably 2 μm or more and 10 μm or less, and more preferably 3 μm or more and 8 μm or less. When the average thickness of the inorganic particle layer is equal to or more than the lower limit mentioned above, occurrence of a short circuit can be further suppressed. On the other hand, when the average thickness of the inorganic particle layer is equal to or less than the upper limit mentioned above, a high energy density can be maintained. The average thickness of the inorganic particle layer is regarded as an average value of thicknesses measured at any ten points.

The total average thickness of the substrate layer and the inorganic particle layer is, for example, preferably 5 μm or more and 60 μm or less, and more preferably 9 μm or more and 30 μm or less. When the total average thickness of the substrate layer and the inorganic particle layer is equal to or more than the lower limit mentioned above, occurrence of a short circuit can be further suppressed. On the other hand, when the total average thickness of the substrate layer and the inorganic particle layer is equal to or less than the above upper limit, high energy density of the nonaqueous electrolyte energy storage device can be achieved. The total average thickness of the substrate layer and the inorganic particle layer is regarded as an average value of thicknesses measured at any ten points.

The lower limit of the porosity of the substrate layer is 10% by volume, preferably 30% by volume. When the porosity of the substrate layer is equal to or more than the lower limit mentioned above, the concentration distribution of lithium ions in the nonaqueous electrolyte in the vicinity of the surface of the negative electrode is made uniform, so that precipitation and growth of a dendrite are further suppressed. On the other hand, the upper limit of the porosity is preferably 80% by volume, and more preferably 60% by volume. When the porosity of the substrate layer is equal to or less than the upper limit mentioned above, penetration of the grown dendrite through the separator can be further suppressed. From these viewpoints, the porosity of the substrate layer is preferably 10% by volume or more and 80% by volume or less, and more preferably 30% by volume or more and 60% by volume or less.

The porosity [% by volume] of the substrate layer is calculated from the following formula.

$$Porosity [ \% by volume ] = 100 - ( W / ( ρ \times t ) \times 100 )$$

W: mass of substrate layer per unit area [g·cm⁻²]
ρ: true density of constituent material [g·cm⁻³]
t: thickness [cm]

### (Nonaqueous Electrolyte)

The nonaqueous electrolyte contains a liquid containing a fluorine atom. The nonaqueous electrolyte usually further contains an electrolyte salt. When the nonaqueous electrolyte contains a liquid containing a fluorine atom, a uniform and stable film is formed on the surface of the negative active material layer, and precipitation and growth of dendrite are suppressed.

The liquid containing a fluorine atom can be appropriately selected from, for example, a nonaqueous solvent containing a known fluorinated solvent, an ionic liquid containing a fluorine atom, and the like. The “fluorinated solvent” refers to a nonaqueous solvent having a fluorine atom in the molecule. The “ionic liquid” in the ionic liquid containing a fluorine atom refers to an ionic compound at least partially in a liquid state at normal temperature (20° C.).

Examples of the fluorinated solvent include fluorinated carbonates, fluorinated ethers, fluorinated carboxylic acid esters, and fluorinated phosphoric acid esters. One of the fluorinated solvents, or two or more thereof can be used.

Examples of the fluorinated carbonate include fluorinated cyclic carbonates and fluorinated chain carbonates. As the fluorinated carbonate, either a fluorinated cyclic carbonate or a fluorinated chain carbonate may be used singly, or a mixture of a fluorinated cyclic carbonate and a fluorinated chain carbonate may be used. Examples of the fluorinated cyclic carbonates include fluorinated ethylene carbonates such as a fluoroethylene carbonate (FEC) and a difluoroethylene carbonate, fluorinated propylene carbonates such as a fluoromethylethylene carbonate, and fluorinated butylene carbonates such as a trifluoroethylethylene carbonate. Among these, fluorinated ethylene carbonates are preferable, and fluoroethylene carbonate is more preferable. As the fluorinated cyclic carbonate, one of these materials may be used singly, or two or more thereof may be mixed and used. Examples of the fluorinated chain carbonate include a trifluoroethyl methyl carbonate (TFEMC) and a bis(trifluoroethyl) carbonate (FDEC). As the fluorinated chain carbonate, one of these materials may be used singly, or two or more thereof may be mixed and used.

The fluorinated ether may be a fluorinated cyclic ether or a fluorinated chain ether, and is preferably a fluorinated chain ether, and is more preferably 1,1,2,2-tetrafluoroethyl-2,2,2-trifluoroethyl ether (TFEE). As the fluorinated ether, one of these materials may be used singly, or two or more thereof may be mixed and used.

Examples of the fluorinated carboxylic acid ester include methyl 3,3,3-trifluoropropionate and 2,2,2-trifluoroethyl acetate. As the fluorinated carboxylic acid ester, one of these materials may be used singly, or two or more thereof may be mixed and used.

Examples of the fluorinated phosphoric acid ester include tris(2,2-difluoroethyl)phosphate and tris(2,2,2-trifluoroethyl)phosphate. As the fluorinated phosphate, one of these materials may be used singly, or two or more thereof may be mixed and used.

Among the fluorinated solvents, fluorinated carbonates are preferred. By containing the fluorinated carbonate, a film having a high content of lithium fluoride which is a reductive decomposition product of the fluorinated carbonate is formed on the surface of the negative active material layer. The film having a high content of lithium fluoride is uniform and stable, and the current distribution is uniformly maintained to suppress the formation of a dendrite, so that the effect of suppressing the occurrence of a short circuit can be further enhanced.

Examples of the cation constituting the ionic liquid containing a fluorine atom include an ammonium cation (quaternary ammonium cation), a phosphonium cation (quaternary phosphonium cation), and a sulfonium cation (tertiary sulfonium cation). The cation constituting the ionic liquid is preferably an ammonium cation, and more preferably a pyrrolium cation. These cations may be used singly, or two or more thereof may be mixed and used.

Examples of the anion constituting the ionic liquid containing a fluorine atom include PF₆⁻, PO₂F₂⁻, BF₄⁻, SO₃CF₃⁻, C(SO₂CF₃)₃⁻, C(SO₂C₂F₅)₃⁻, N(SO₂F)₂⁻ (bis(fluorosulfonyl)imide anion), N(CF₃SO₂)₂⁻ (bis(trifluoromethanesulfonyl)imide anion), N(C₂F₅SO₂)₂⁻ (bis(pentafluoroethanesulfonyl)imide anion), N(C₄F₉SO₂)₂⁻ (bis(nonafluorobutanesulfonyl)imide anion), N(POF₂)₂⁻ (bis(difluorophosphonyl)imide anion), N(CF₃SO₂)(CF₃CO)⁻ ((trifluoromethanesulfonyl) (trifluoromethanecarbonyl)imide anion), CF₃—SO₂—N—SO₂—N—SO₂CF₃⁻, FSO₂—N—SO₂—C₄F₉⁻, CF₃—SO₂—N—SO₂-CAF₉⁻, CF₃—SO₂—N—SO₂—CF₂—SO₂—N—SO₂—CF₃₂⁻, CF₃—SO₂—N—SO₂—CF₂—SO₃₂⁻, and CF₃—SO₂—N—SO₂—CF₂—SO₂—C(—SO₂CF₃)₂₂⁻. These anions may be used singly, or two or more thereof may be mixed and used.

The nonaqueous electrolyte may contain a nonaqueous solvent other than a liquid containing a fluorine atom. Examples of other nonaqueous solvents include cyclic carbonate, chain carbonate, ester, ether, amide, sulfone, lactone, and nitrile. In addition, a nonaqueous solvent containing sulfur such as sulfone or sulfite may be contained.

The nonaqueous electrolyte preferably contains a nonaqueous solvent containing a fluorinated solvent. When the nonaqueous electrolyte contains the nonaqueous solvent containing the fluorinated solvent, the effect of suppressing the occurrence of a short circuit in the nonaqueous electrolyte energy storage device can be further enhanced. The lower limit of the content of the fluorinated solvent in the nonaqueous solvent may be preferably 12% by volume, more preferably 20% by volume, still more preferably 30% by volume, and particularly preferably 50% by volume. The upper limit of the content of the fluorinated solvent in the nonaqueous solvent is preferably 100% by volume, more preferably 90% by volume, still more preferably 80% by volume, and particularly preferably 70% by volume. The content of the fluorinated solvent in the nonaqueous solvent may be preferably 12% by volume or more and 100% by volume or less, more preferably 20% by volume or more and 90% by volume or less, still more preferably 30% by volume or more and 80% by volume or less, and particularly preferably 50% by volume or more and 70% by volume or less. When the content of the fluorinated solvent is within the above range, the effect of suppressing the occurrence of a short circuit in the nonaqueous electrolyte energy storage device can be further enhanced.

The lower limit of the content of the liquid containing a fluorine atom in the entire liquid of the nonaqueous electrolyte may be preferably 50% by volume, more preferably 70% by volume, still more preferably 80% by volume, yet still more preferably 90% by volume, and particularly preferably 93% by volume. The upper limit of the content of the liquid containing a fluorine atom in the whole liquid of the nonaqueous electrolyte may be preferably 100% by volume, more preferably 99% by volume, still more preferably 98% by volume, yet still more preferably 97% by volume, and particularly preferably 96% by volume. The content of the liquid containing a fluorine atom in the entire liquid of the nonaqueous electrolyte may be preferably 50% by volume or more and 100% by volume or less, more preferably 70% by volume or more and 99% by volume or less, still more preferably 80% by volume or more and 98% by volume or less, yet still more preferably 90% by volume or more and 97% by volume or less, and particularly preferably 93% by volume or more and 96% by volume or less. When the content of the liquid containing a fluorine atom is equal to or more than the lower limit mentioned above, the effect of suppressing the occurrence of a short circuit in the nonaqueous electrolyte energy storage device can be further enhanced.

The electrolyte salt is usually a lithium salt.

Examples of the lithium salt include inorganic lithium salts such as LiPF₆, LiPO₂F₂, LiBF₄, LiCIO₄, and LiN(SO₂F)₂, lithium oxalates such as lithium bis(oxalate) borate (LiBOB), lithium difluorooxalatoborate (LiFOB), and lithium bis(oxalate)difluorophosphate (LiFOP), and lithium salts having a halogenated hydrocarbon group, such as LiSO₃CF₃, LiN(SO₂CF₃)₂, LiN(SO₂C₂F₅)₂, LIN (SO₂CF₃) (SO₂C+F₉), LiC(SO₂CF₃)₃, and LiC(SO₂C₂F₅)₃. Among these salts, the inorganic lithium salts are preferable, and LiPF₆ is more preferable. As the lithium salt, one of these materials may be used singly, or two or more thereof may be mixed and used.

The content of the electrolyte salt in the nonaqueous electrolyte is, at 20° C. under 1 atm, preferably 0.1 mol/dm³ or more and 2.5 mol/dm³ or less, more preferably 0.3 mol/dm³ or more and 2.0 mol/dm³ or less, still more preferably 0.5 mol/dm³ or more and 1.7 mol/dm³ or less, particularly preferably 0.7 mol/dm³ or more and 1.5 mol/dm³ or less. When the content of the electrolyte salt is the above range, the ionic conductivity of the nonaqueous electrolyte can be increased.

The nonaqueous electrolyte may contain an additive in addition to the liquid containing a fluorine atom and the electrolyte salt. Examples of the additive include oxalic acid salts such as lithium bis(oxalate) borate (LiBOB), lithium difluorooxalatoborate (LiFOB), and lithium bis(oxalate)difluorophosphate (LiFOP); imide salts such as lithium bis(fluorosulfonyl)imide (LiFSI); aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds, such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; vinylene carbonate, methylvinylene carbonate, ethylvinylene carbonate, succinic anhydride, glutaric anhydride, maleic anhydride, citraconic anhydride, glutaconic anhydride, itaconic anhydride, cyclohexanedicarboxylic anhydride; ethylene sulfite, propylene sulfite, dimethyl sulfite, methyl methanesulfonate, busulfan, methyl toluenesulfonate, dimethyl sulfate, ethylene sulfate, sulfolane, dimethyl sulfone, diethyl sulfone, dimethylsulfoxide, diethylsulfoxide, tetramethylene sulfoxide, diphenyl sulfide, 4,4′-bis(2,2-dioxo-1,3,2-dioxathiolane, 4-methylsulfonyloxymethyl-2,2-dioxo-1,3,2-dioxathiolane, thioanisole, diphenyl disulfide, dipyridinium disulfide, 1,3-propene sultone, 1,3-propane sultone, 1,4-butane sultone, 1,4-butene sultone, perfluorooctane, tristrimethylsilyl borate, tristrimethylsilyl phosphate, tetrakistrimethylsilyl titanate, lithium monofluorophosphate, and lithium difluorophosphate. One of these additives may be used singly, or two or more thereof may be mixed and used.

The content of the additive contained in the nonaqueous electrolyte is preferably 0.01% by mass or more and 7% by mass or less, more preferably 0.1% by mass or more and 5% by mass or less, still more preferably 0.2% by mass or more and 3% by mass or less, and particularly preferably 0.3% by mass or more and 2% by mass or less, with respect to the total mass of the nonaqueous electrolyte. When the content of the additive falls within the above range, thereby making it possible to improve capacity retention performance or cycle performance after high-temperature storage, and to further improve safety.

The shape of the nonaqueous electrolyte energy storage device according to the present embodiment is not particularly limited, and examples thereof include cylindrical batteries, prismatic batteries, flat batteries, coin batteries and button batteries.

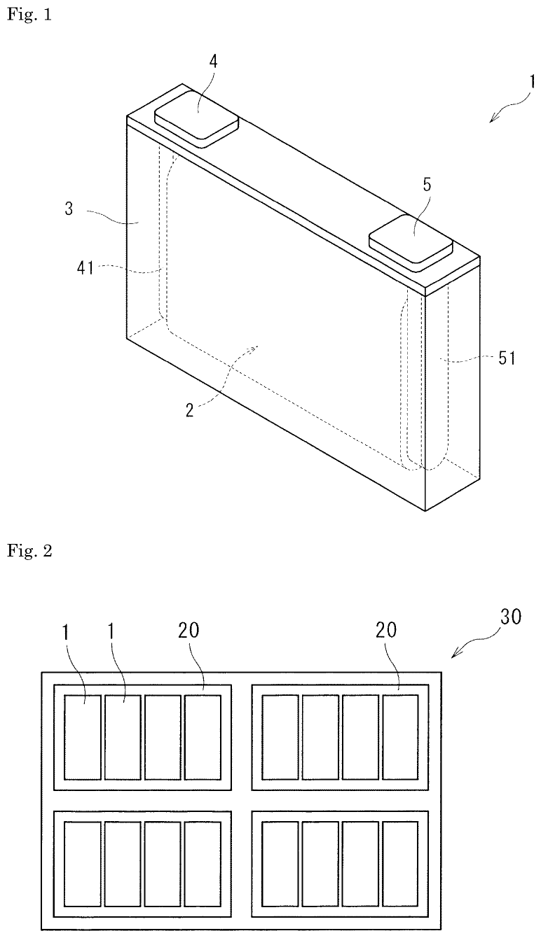

FIG. 1 illustrates a nonaqueous electrolyte energy storage device 1 as an example of prismatic batteries. FIG. 1 is a view illustrating the inside of a case in a perspective manner. An electrode assembly 2 including a positive electrode and a negative electrode wound with a separator interposed therebetween is housed in a prismatic case 3. The positive electrode is electrically connected to a positive electrode terminal 4 via a positive electrode lead 41. The negative electrode is electrically connected to a negative electrode terminal 5 via a negative electrode lead 51.

### <Configuration of Energy Storage Apparatus>

The nonaqueous electrolyte energy storage device according to the present embodiment can be mounted as an energy storage apparatus including an energy storage unit (battery module) configured by assembling a plurality of nonaqueous electrolyte energy storage devices on a power source for automobiles such as electric vehicles (EVs), hybrid vehicles (HEVs), and plug-in hybrid vehicles (PHEVs), a power source for electronic devices such as personal computers and communication terminals, or a power source for power storage, or the like. In this case, the technique of the present invention may be applied to at least one nonaqueous electrolyte energy storage device included in the energy storage apparatus.

FIG. 2 illustrates an example of an energy storage apparatus 30 formed by assembling energy storage units 20 in each of which two or more electrically connected nonaqueous electrolyte energy storage devices 1 are assembled. The energy storage apparatus 30 may include a busbar (not illustrated) for electrically connecting two or more nonaqueous electrolyte energy storage devices 1 and a busbar (not illustrated) for electrically connecting two or more energy storage units 20. The energy storage unit 20 or the energy storage apparatus 30 may include a state monitor (not illustrated) that monitors the state of one or more nonaqueous electrolyte energy storage devices 1.

### <Method for Manufacturing Nonaqueous Electrolyte Energy Storage Device>

A method for manufacturing the nonaqueous electrolyte energy storage device of the present embodiment can be appropriately selected from publicly known methods. The manufacturing method includes, for example, preparing an electrode assembly, preparing a nonaqueous electrolyte, and housing the electrode assembly and the nonaqueous electrolyte in a case. The preparation of the electrode assembly includes: preparing a positive electrode and a negative electrode, and forming an electrode assembly by stacking or winding the positive electrode and the negative electrode with a separator interposed therebetween.

Housing the nonaqueous electrolyte in the case can be appropriately selected from known methods. For example, after a nonaqueous electrolyte containing a liquid containing a fluorine atom is injected from an injection port formed in a case, the injection port may be sealed. The details of each element constructing the nonaqueous electrolyte energy storage device obtained by the manufacturing method are as described above.

### Other Embodiments

The nonaqueous electrolyte energy storage device according to the present invention is not limited to the embodiment described above, and various changes may be made without departing from the gist of the present invention. For example, to the configuration of one embodiment, the configuration of another embodiment can be added, and a part of the configuration of one embodiment can be replaced by the configuration of another embodiment or a well-known technique. Furthermore, a part of the configuration according to one embodiment can be deleted. In addition, a well-known technique can be added to the configuration according to one embodiment.

In the above embodiment, although the case where the nonaqueous electrolyte energy storage device is used as a nonaqueous electrolyte secondary battery (for example, lithium secondary battery) that can be charged and discharged has been described, the type, shape, size, capacity, and the like of the nonaqueous electrolyte energy storage device are arbitrary. The present invention can also be applied to various secondary batteries, and capacitors such as electric double layer capacitors and lithium ion capacitors.

### EXAMPLES

Hereinafter, the present invention will be described more specifically with reference to examples. The present invention is not limited to the following Examples.

### Example 1

### (Fabrication of Negative Electrode)

On one surface of a copper foil of 10 μm in average thickness as a negative substrate, a lithium metal foil (lithium metal 100% by mass) of 100 μm in average thickness was layered as a negative active material layer, pressed, and then cut into a rectangular shape of 32 mm in width and 42 mm in length, thereby fabricating a negative electrode.

### (Fabrication of Positive Electrode)

As a positive active material, a lithium-transition metal composite oxide, which had an α-NaFeO₂-type crystal structure and was represented by Li_{1+α}Me_{1-α}O₂ (Me was a transition metal element), was used. In this regard, the molar ratio Li/Me of Li to Me was 1.33, and Me was composed of Ni and Mn and was contained at a molar ratio of Ni:Mn=0.33:0.67.

A positive composite paste containing the positive active material, acetylene black (AB) as a conductive agent, and polyvinylidene fluoride (PVDF) as a binder at a mass ratio of 92.5:4.5:3.0 in terms of solid content, was prepared using N-methylpyrrolidone (NMP) as a dispersion medium. The positive composite paste was applied to one surface of an aluminum foil with an average thickness of 15 μm as a positive substrate, and dried, and the resultant was pressed and cut to fabricate a positive electrode having a positive active material layer disposed in a rectangular shape having a width of 30 mm and a length of 40 mm.

### (Preparation of Nonaqueous Electrolyte)

Fluoroethylene carbonate (FEC) and 2,2,2-trifluoroethyl methyl carbonate (TFEMC) were used as nonaqueous solvents. Then, LiPF₆ was dissolved at a concentration of 1 mol/dm³ in a mixed solvent mixed at a volume ratio of FEC:TFEMC=30:70, and then 2% by mass of 1,3-propenesultone (PRS) as an additive was mixed to obtain a nonaqueous electrolyte.

### (Preparation of Separator)

As a separator, a microporous film-like substrate layer composed only of a polyolefin-based resin and having an average thickness of 15 μm and a separator composed of an inorganic particle layer layered on both surfaces of the substrate layer and having air permeability shown in Table 1 were used. As the inorganic particle layer, a layer containing inorganic particles and a binder and having an average thickness of each layer of 3 μm was used. As the inorganic particles, inorganic particles having an average particle size of about 500 nm were used.

### (Fabrication of Nonaqueous Electrolyte Energy Storage Device)

The positive electrode and the negative electrode were layered with the separator interposed therebetween, thereby fabricating an electrode assembly. The inorganic particle layer of the separator was disposed so as to be interposed between the substrate layer and the negative active material layer of the separator and between the substrate layer and the positive active material layer of the separator. The electrode assembly was housed in a case, the nonaqueous electrolyte was injected into the case, and then the case was sealed to obtain a nonaqueous electrolyte energy storage device of Example 1.

### Comparative Example 1

A nonaqueous electrolyte energy storage device of Comparative Example 1 was obtained in the same manner as in Example 1 except that a separator which was composed only of a microporous film-like substrate layer composed only of a polyolefin-based resin and had an average thickness of 15 μm and had air permeability shown in Table 1 was used.

### Example 2

A nonaqueous electrolyte energy storage device of Example 2 was obtained in the same manner as in Example 1 except that a separator including a microporous film-like substrate layer composed only of a polyolefin-based resin and having an average thickness of 9 μm and an inorganic particle layer layered on both surfaces of the substrate layer and having air permeability shown in Table 1 was used. As the inorganic particle layer, a layer containing inorganic particles and a binder and having an average thickness of each layer of 6 μm was used. As the inorganic particles, inorganic particles having an average particle size of about 500 nm were used.

### Example 3

A nonaqueous electrolyte energy storage device of Example 3 was obtained in the same manner as in Example 1 except that a separator including a microporous film-like substrate layer composed only of a polyolefin-based resin and having an average thickness of 12 μm and an inorganic particle layer layered on both surfaces of the substrate layer and having air permeability shown in Table 1 was used. As the inorganic particle layer, a layer containing inorganic particles and a binder and having an average thickness of each layer of 4 μm was used. As the inorganic particles, inorganic particles having an average particle size of about 500 nm were used.

### Comparative Example 2

A nonaqueous electrolyte energy storage device of Comparative Example 2 was obtained in the same manner as in Example 1 except that a separator including a microporous film-like substrate layer composed only of a polyolefin-based resin and having an average thickness of 15 μm and an inorganic particle layer layered on both surfaces of the substrate layer and having air permeability shown in Table 1 was used. As the inorganic particle layer, a layer containing inorganic particles and a binder and having an average thickness of each layer of 3 μm was used. As the inorganic particles, inorganic particles having an average particle size of about 500 nm were used.

### Example 4

A nonaqueous electrolyte energy storage device of Example 4 was obtained in the same manner as in Example 1 except that a separator including a microporous film-like substrate layer composed only of a polyolefin-based resin and having an average thickness of 19 μm and an inorganic particle layer layered on one surface of the substrate layer and having air permeability shown in Table 1 was used, and the inorganic particle layer was disposed so as to be interposed between the substrate layer of the separator and the negative active material layer. As the inorganic particle layer, a layer containing inorganic particles and a binder and having an average thickness of 4 μm was used. As the inorganic particles, inorganic particles having an average particle size of about 500 nm were used.

### Comparative Example 3

A nonaqueous electrolyte energy storage device of Comparative Example 3 was obtained in the same manner as in Example 1 except that a separator including a microporous film-like substrate layer composed only of a polyolefin-based resin and having an average thickness of 9 μm and an inorganic particle layer layered on both surfaces of the substrate layer and having air permeability shown in Table 1 was used, and 1,3-propenesultone (PRS) as an additive was not mixed with the nonaqueous electrolyte. As the inorganic particle layer, a layer containing inorganic particles and a binder and having an average thickness of each layer of 6 μm was used. As the inorganic particles, inorganic particles having an average particle size of about 500 nm were used.

### Example 5

A nonaqueous electrolyte energy storage device of Example 5 was obtained in the same manner as in Example 4 except that 1,3-propenesultone (PRS) as an additive was not mixed with a nonaqueous electrolyte.

### Comparative Example 4

A nonaqueous electrolyte energy storage device of Comparative Example 4 was obtained in the same manner as in Example 5 except that the separator was disposed such that the inorganic particle layer was interposed between the substrate layer of the separator and the positive active material layer.

### Comparative Example 5

A nonaqueous electrolyte energy storage device of Comparative Example 5 was obtained in the same manner as in Example 5 except that as for the composition of the nonaqueous solvent, LiPF₆ was dissolved at a concentration of 1 mol/dm³ in a mixed solvent prepared by mixing ethylene carbonate (EC) and ethyl methyl carbonate (EMC) at a volume ratio of 30:70 to obtain a nonaqueous electrolyte.

### Comparative Example 6

A nonaqueous electrolyte energy storage device of Comparative Example 6 was obtained in the same manner as in Example 1 except that a separator including a microporous film-like substrate composed only of a polyolefin-based resin and having an average thickness of 15 μm and an inorganic particle layer layered on one surface of the substrate layer and having air permeability shown in Table 1 was used, and the inorganic particle layer was disposed so as to be interposed between the substrate layer of the separator and the negative active material layer, and 1,3-propenesultone (PRS) as an additive was not mixed with the nonaqueous electrolyte. As the inorganic particle layer, a layer containing inorganic particles and a binder and having an average thickness of 6 μm was used. As the inorganic particles, inorganic particles having an average particle size of about 500 nm were used.

### Comparative Example 7

A nonaqueous electrolyte energy storage device of Comparative Example 7 was obtained in the same manner as in Comparative Example 6 except that as for the composition of the nonaqueous solvent, LiPF₆ was dissolved at a concentration of 1 mol/dm³ in a mixed solvent prepared by mixing ethylene carbonate (EC) and ethyl methyl carbonate (EMC) at a volume ratio of 30:70 to obtain a nonaqueous electrolyte.

### (Initial Charge-Discharge)

The obtained respective nonaqueous electrolyte solution energy storage devices were subjected to the initial charge-discharge under the following conditions. Constant current charge was performed at 25° C. at a charge current of 0.1 C, and then constant voltage charge was performed at 4.6 V. With regard to the charge termination conditions, charge was performed until the charge current reached 0.05 C. Thereafter, a pause time of 10 minutes was provided. Thereafter, constant current discharge was performed at a discharge current of 0.1 C and an end-of-discharge voltage of 2.0 V, and then a pause time of 10 minutes was provided. This charge-discharge was performed 2 cycles.

### (Number of Cycles Until Occurrence of Short Circuit)

For each nonaqueous electrolyte solution energy storage device after initial charge-discharge, the number of cycles until occurrence of a short circuit was evaluated by the following procedure. Constant current charge was performed at 25° C. at a charge current of 0.2 C, and then constant voltage charge was performed at 4.6 V. With regard to the charge termination conditions, charge was performed until the charge current reached 0.05 C. Thereafter, a pause time of 10 minutes was provided. Thereafter, constant current discharge was performed at a discharge current of 0.1 C and an end-of-discharge voltage of 2.0 V, and then a pause time of 10 minutes was provided. This charge-discharge cycle was repeated, and the number of cycles was recorded until causing a short circuit. Presence or absence of occurrence of a short circuit was confirmed by a decrease in coulombic efficiency in charge-discharge and an increase in the amount of charge. Specifically, it was determined that the short circuit occurred when the coulombic efficiency was less than 98% and the amount of charge exceeded the immediately preceding discharge capacity. The evaluation results of the number of cycles until occurrence of short circuit are shown in Table 1.

TABLE 1

| | | | Nonaqueous solvent content | | | | | Evaluation |
|---|---|---|---|---|---|---|---|---|
| | | | [% by volume] | | | | | Number of |
| | | | Fluorinated | | Non-fluorinated | | Additive | cycles until |
| | Separator | | solvent | | solvent | | PRS | occurrence |
| | Inorganic particle | Air permeability | Cyclic | Chain | Cyclic | Chain | [% by | of short |
| | layer | [sec/100 cm³] | FEC | TFEMC | EC | EMC | mass] | circuit |
| Comparative | Absence | 142 | 30 | 70 | — | — | 2 | 30 |
| Example 1 | | | | | | | | |
| Comparative | Both surfaces | 100 | 30 | 70 | — | — | 2 | 90 |
| Example 2 | | | | | | | | |
| Example 1 | Both surfaces | 137 | 30 | 70 | — | — | 2 | 120 |
| Example 2 | Both surfaces | 191 | 30 | 70 | — | — | 2 | 120 |
| Example 3 | Both surfaces | 202 | 30 | 70 | — | — | 2 | 125 |
| Comparative | Both surfaces | 574 | 30 | 70 | — | — | — | 20 |
| Example 3 | | | | | | | | |
| Example 4 | Negative electrode | 260 | 30 | 70 | — | — | 2 | 170 |
| | surface | | | | | | | |
| Example 5 | Negative electrode | 260 | 30 | 70 | — | — | — | 170 |
| | surface | | | | | | | |
| Comparative | Positive electrode | 260 | 30 | 70 | — | — | — | 20 |
| Example 4 | surface | | | | | | | |
| Comparative | Negative electrode | 260 | — | — | 30 | 70 | — | 16 |
| Example 5 | surface | | | | | | | |
| Comparative | Negative electrode | 90 | 30 | 70 | — | — | — | 55 |
| Example 6 | surface | | | | | | | |
| Comparative | Negative electrode | 90 | — | — | 30 | 70 | — | 10 |
| Example 7 | surface | | | | | | | |

As shown in Table 1, in the nonaqueous electrolyte energy storage devices of Examples 1 to 5 in which the surface of the negative active material layer and the surface of the inorganic particle layer were stacked so as to face each other, and the air permeability of the separator was 110 [sec/100 cm³] or more and 450 [sec/100 cm³] or less, the number of cycles until occurrence of a short circuit exceeded 100, and the occurrence of a short circuit was sufficiently suppressed.

On the other hand, Comparative Example 1 in which the inorganic particle layer was not included, Comparative Example 2 in which the air permeability of the separator was less than 110 [sec/100 cm³], Comparative Example 6 and Comparative Example 7, Comparative Example 3 in which the air permeability of the separator was more than 450 [sec/100 cm³], Comparative Example 4 in which the surface of the negative active material layer and the surface of the inorganic particle layer were not stacked so as to face each other, and Comparative Example 5 in which the nonaqueous electrolyte did not contain a liquid containing a fluorine atom resulted in low suppression effects on the occurrence of a short circuit.

As a result, it was shown that the nonaqueous electrolyte energy storage device has a high suppressing effect on the occurrence of a short circuit.

### DESCRIPTION OF REFERENCE SIGNS

1: Nonaqueous electrolyte energy storage device
2: Electrode assembly
3: Case
4: Positive electrode terminal
41: Positive electrode lead
5: Negative electrode terminal
51: Negative electrode lead
20: Energy storage unit
30: Energy storage apparatus

1. Nonaqueous electrolyte energy storage device, comprising:
a negative electrode having a negative active material layer containing lithium metal;
a positive electrode having a positive active material layer;
a nonaqueous electrolyte containing a liquid containing a fluorine atom; and
a separator having a substrate layer and an inorganic particle layer layered on a surface of the substrate layer,
wherein the surface of the negative active material layer and the surface of the inorganic particle layer are stacked so as to face each other, and
the separator has an air permeability of 110 [sec/100 cm³] or more and 450 [sec/100 cm³] or less.

2. The nonaqueous electrolyte energy storage device according to claim 1, wherein
the nonaqueous electrolyte contains a nonaqueous solvent containing a fluorinated solvent, and
a content of the fluorinated solvent in the nonaqueous solvent is 12% by volume or more.
